(19) United States
(12) Patent Application Publication
(10) Pub. No.: US 2026/0230308 A1
(43) Pub. Date: Aug. 6, 2026

(54) A METHOD, A COMPUTER PROGRAM AND AN APPARATUS FOR AN ENCLAVE ENTITY, FOR A TRUSTED ENTITY, AND FOR SECURING INFORMATION ABOUT A MASTER SECRET KEY OF A BACKUP OF A PRIVATE MEMORY REGION, AN ENCLAVE ENTITY AND A TRUSTED ENTITY

(71) Applicant: Sony Group Corporation, Tokyo (JP)

(72) Inventors: Michele MINELLI, Stuttgart (DE); Hugo EMBRECHTS, Stuttgart (DE); Dimitri TORFS, Stuttgart (DE); Kasper DE BLIECK, Stuttgart (DE); Mykola IVANOV, Stuttgart (DE)

(73) Assignee: Sony Group Corporation, Tokyo (JP)

(21) Appl. No.: 19/149,864

(22) PCT Filed: Mar. 15, 2024
(86) PCT No.: PCT/EP2024/057064

§ 371 Date: Jul. 22, 2025

(30) Foreign Application Priority Data
Mar. 23, 2023 (EP) 23163621.8

(51) Int. Cl. H04L 9/08

(52) U.S. Cl. CPC H04L 9/085; H04L 9/0894

(57) ABSTRACT

Examples relate to an enclave entity, a trusted entity, a method, a computer program and an apparatus for an enclave entity, a trusted entity, and for securing information about a master secret key of a backup of a private memory region. The method for the enclave entity comprising generating a plurality of shards based on the master key, wherein a predefined number of the shards, which is lower or equal to a number of shards in the plurality, form an information basis for reconstructing the master secret key; receiving key information from a plurality of trusted entities; encrypting the plurality of shards individually using the key information from the plurality of trusted entities to obtain a plurality of encrypted shards; and providing the plurality of encrypted shards to the plurality of trusted entities.

### FIELD

Examples relate to an enclave entity, a trusted entity, a method, a computer program and an apparatus for an enclave entity, for a trusted entity, and for securing information about a master secret key of a backup of a private memory region, more specifically, but not exclusively, to a concept for storing and restoring encrypted shards of a master secret key of a memory backup at distributed trusted entities.

### BACKGROUND

Enclaves may correspond to private regions of memory on specific or certain processors, where the private memory regions are disconnected from other parts of the system. Code running within the enclave and data stored in the enclave are encrypted and decrypted on the fly, keeping everything within the enclave secret to other parts of the application, superusers and even the operating system. Enclaves can be used for the most sensitive parts of an application to assure security. The use of enclaves allows one to create software, which handles private data in the clear. Everything is encrypted towards the outside. This allows the application to process sensitive user data in isolation, without revealing it to the application itself. Even elevated processes or superusers cannot access the content running in the isolated enclave.

When an untrusted part of an application needs to work with sensitive data or protected code, it can spin up an enclave. The application can call a trusted function connecting to the enclave via a secure channel. The enclave may perform trusted actions like decrypting sensitive data and processing the data in plain text. The enclave may protect code and assure the integrity, because no malicious intruder can access the enclave due to encryption. When all sensitive operations are finished, the enclave returns the result to the untrusted part of the app. The untrusted part can use the result without ever having access to the sensitive component.

### SUMMARY

Examples are based on the finding that the protection of backups of private memory regions or enclaves are dependent on the protection of a master secret key, which is used for the encryption of the backup of the memory. If the master secret key is lost, then encrypted data of a backup is also lost, because it cannot be decrypted anymore. Therefore, examples provide a concept for safely storing and restoring a master secret key. The master secret key can be broken down in parts, so-called shards, which can be combined for restoring the master secret key. One shard alone might not be enough for restoring master secret key but two or more are needed. Moreover, more shards than necessary for the reconstruction can be generated. Hence, even if some of the shards are lost the remining shards may still suffice for reconstructing the master secret key.

Examples provide a method for an enclave entity and for securing information about a master secret key of a backup of a private memory region. The method comprises generating a plurality of shards based on the master key. A predefined number of the shards, which is lower or equal to a number of shards in the plurality, forms an information basis for reconstructing the master secret key. The method further comprises receiving key information from a plurality of trusted entities and encrypting the plurality of shards individually using the key information from the plurality of trusted entities to obtain a plurality of encrypted shards. The method further comprises providing the plurality of encrypted shards to the plurality of trusted entities. Examples enable secured storage of a master secret key by storing encrypted shards of the master secret key at distinct and distributed trusted entities.

In further examples the method may comprise documenting the providing of an encrypted shard to a trusted entity. The documenting may allow other entities, in particular the trusted entities, to verify the provision of the encrypted shard by the enclave entity. Moreover, the documenting may include storing information about the providing in a distributed ledger. Storing in a distributed ledger may further enhance authenticity of the provision of the encrypted shard by the enclave entity as any modification or manipulation of the documentation would become visible or detectable.

The method may further comprise restoring the master secret key by providing further key information to at least the predefined number of trusted entities. The method further comprises requesting shard information from at least the predefined number of trusted entities and receiving encrypted shard information from at least the predefined number of trusted entities. The method may further comprise decrypting the encrypted shard information based on the further key information to obtain at least the predefined number of decrypted shards and restoring the master secret key based on at least the predefined number of decrypted shards. Examples may allow restoring the master secret key without communicating or storing unencrypted or unprotected shards.

In further examples, the method may include providing an attestation of the enclave entity to at least the predefined number of trusted entities. Therewith, the trusted entities can verify or authenticate the request from the enclave entity. At least in some examples a storing of the information about restoring the master secret key in a distributed ledger may take place. Storing in the distributed ledger may enable the trusted entities to carry out an according verification or authentication of the master secret key restoration by the enclave entity.

The method may further comprise obtaining information about provision of an encrypted shard from a trusted entity from a distributed ledger and authenticating the trusted entity using the information about the provision. Hence, the enclave entity may use information stored by the trusted entities on a distributed ledger to verify or authenticate their provision of the encrypted shards. Furthermore, the method may comprise storing information about completing the restoring of the master secret key in a distributed ledger. Therewith, other entities can verify the successful completion of the restoring of the master secret key. In examples, the requesting of the shard information may include communication with the trusted entities through an untrusted operator. Examples may enable communication through untrusted entities because the key shards are always encrypted when communicated and actions, e.g. requests or reactions to request, may be documented in a verifiable way.

A further example is a computer program having a program code for performing a method for an enclave entity as described herein, when the computer program is executed on a computer, a processor, or a programmable hardware component. Yet another example is an apparatus for an enclave entity and for securing information about a master secret key of a backup of a private memory region comprising circuitry configured to perform a method for an enclave entity as described herein. Another example is an enclave entity comprising the apparatus.

Examples also provide a method for a trusted entity and for securing information about a master secret key of a backup of a private memory region. The method comprises providing key information to an enclave entity and receiving information on an encrypted shard from the enclave entity. The method further comprises storing the information on the encrypted shard. Examples enable distributed storing of the encrypted shards at trusted entities, which allows safe and reliable reconstruction of the master secret key.

In line with the above, the method for the trusted entity may further comprise documenting reception of an encrypted shard from the enclave entity. This may enable the enclave entity to verify the process at the trusted entity. The documenting may comprise storing information about the reception in a distributed ledger. Thereby, modification or manipulation of such information becomes detectable.

In further examples, the method further comprises providing information on re-encrypted shards back to the enclave entity. This may include receiving further key information and a request for shard information from the enclave entity and restoring the encrypted shard information. The method may further comprise decrypting the encrypted shard information based on the key information and re-encrypting the shard information based on the further key information to obtain re-encrypted shard information. The re-encrypted shard information is then provided to the enclave entity. Thereby, examples enable restoring the master secret key at the enclave entity without ever communicating un-encrypted shards.

At the trusted entity the method may also comprise verifying information about restoring the master secret key associated with the shard by the enclave entity from a distributed ledger. Examples may enable the trusted entities to verify that the enclave entity really started a restoring process for the master secret key. In some examples, the method at the trusted entity may further include receiving attestation information from the enclave entity and verifying a restoration of the master secret key by the enclave entity based on the attestation information. The attestation information may be used to authenticate the enclave entity. E.g. using a certificate, which can be verified using another trusted entity. Likewise, the method at the trusted entity can comprise providing information about providing of the re-encrypted shard to the enclave entity to a distributed ledger. This in turn enables the enclave entity to verify processing steps and action at the trusted entity. Example may further enable communicating with the enclave entity through an untrusted operator. Communication through untrusted entities may be enabled by encrypted communication, attestation and documentation of the respective processing steps on both sides.

Examples also provide a computer program having a program code for performing a method for a trusted entity as described herein, when the computer program is executed on a computer, a processor, or a programmable hardware component. Another example is an apparatus for a trusted entity and for securing information about a master secret key of a backup of a private memory region comprising circuitry configured for performing one of the methods for a trusted entity described herein. Another example is a trusted entity comprising the apparatus. Yet another example is system comprising an enclave entity and one or more trusted entities in line with the present description.

### BRIEF DESCRIPTION OF THE FIGURES

Some examples of apparatuses and/or methods will be described in the following by way of example only, and with reference to the accompanying figures, in which

FIG. 1 shows a bock diagram of a flow chart of an example of a method for an enclave entity and for securing information about a master secret key of a backup of a private memory region;

FIG. 2 shows a bock diagram of a flow chart of an example of a method for a trusted entity and for securing information about a master secret key of a backup of a private memory region;

FIG. 3 shows a block diagram of an example of an apparatus for an enclave entity and an apparatus for a trusted entity;

FIG. 4 illustrates an example of an enclave entity;

FIG. 5 depicts an example of an enclave entity using an encrypted backup of a private memory region;

FIG. 6 shows effects resulting from a loss of a master secret key at an enclave entity;

FIG. 7 illustrates effects resulting from a compromised master secret key;

FIG. 8 depicts distribution of encrypted shards to multiple trusted entities in an example;

FIG. 9 shows restoring of a master secret key in an example; and

FIG. 10 illustrates documentation on a distributed ledger in an example.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

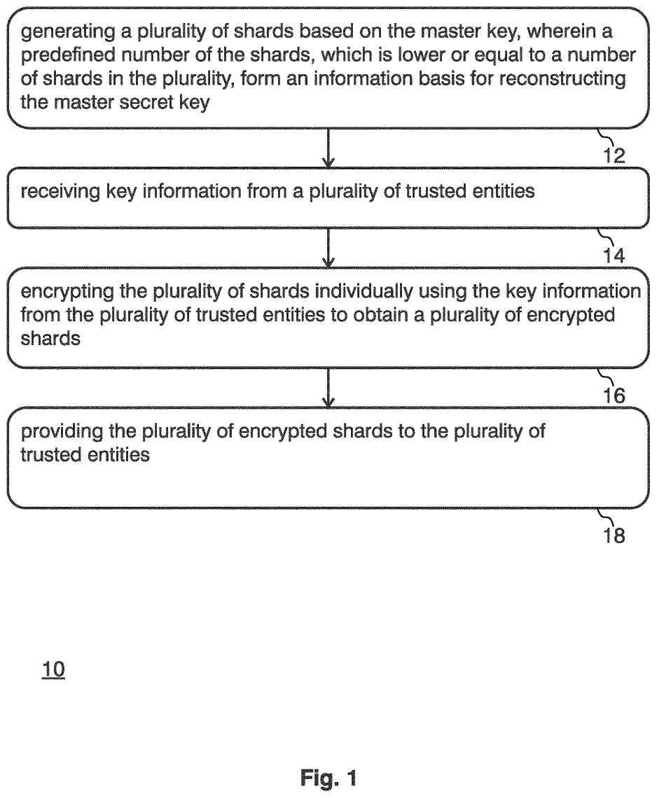

FIG. 1 shows a bock diagram of a flow chart of an example of a method 10 for an enclave entity and for securing information about a master secret key of a backup of a private memory region. The method 10 comprises generating 12 a plurality of shards based on the master key. A predefined number of the shards, which is lower or equal to a number of shards in the plurality, form an information basis for reconstructing the master secret key. The method 10 further comprises receiving 14 key information from a plurality of trusted entities and encrypting 16 the plurality of shards individually using the key information from the plurality of trusted entities to obtain a plurality of encrypted shards. The method 10 further comprises providing 18 the plurality of encrypted shards to the plurality of trusted entities.

In examples an enclave entity may be an entity that provides a trusted execution environment. In general, a trusted execution environment is an execution environment that is encapsulated from (i.e., shielded from) other processes being executed on the processing circuitry providing the trusted execution environment. In particular, processes being executed outside the particular trusted execution environment may be unable to read out, or write into, data or code being contained in the trusted execution environment. In the proposed concept, the private memory region might not be accessible from outside the trusted execution environment. For example, a software code of the enclave entity as well as the private memory region the enclave is using may be cryptographically protected. The contents of the private memory region may remain shielded inside the trusted execution environment or enclave at any point. An example of such an environment is Intel SGX. Other examples of TEE (Trusted Execution Environment) include AMD SEV (Secure Encrypted Virtualization) and Arm Trustzone.

A trusted entity refers to an individual, organization, or system that is considered reliable and trustworthy, and whose actions or motives can be trusted. It could be a computer or a software that has been verified and authenticated and has demonstrated a track record of delivering dependable and secure services. In the present context, trusted entities such as verified software or authenticated computers are granted certain privileges and access rights that untrusted entities do not have, as they are considered less of a risk to the security of a system or network. They are particularly trusted in storing the encrypted shards in a protected way at a low risk of losing or compromising said information.

The backup of the private memory region, which can be stored outside the enclave entity is also cryptographically protected by the master secret key (MSK). The MSK may be symmetric or it may be part of an asymmetric key pair, e.g. a master secret public and private key. The generating 12 of the plurality of shards can be based on Shamir's secret sharing algorithm or any other code, that allows reconstruction of the master secret key by a predefined number of shards. The overall number of shards may be greater than the predefined number. In some examples, any subset of the predefined number of shards may suffice the reconstruction of the master secret key. For example, block codes, such as Reed-Solomon codes or any forward error correction code may be used for generating the shards.

The key information exchanged between trusted entities and the enclave entity may be symmetric or asymmetric. E.g. each entity may generate pair of a public and private key and the public keys may be communicated to the respective other entities. The public keys can then be used for encryption and the private keys, which remain at the respective entities, can be used for decryption. The communication (provision/transmission/reception of information) between the enclave entity and the trusted entities may be through communication networks, e.g. any wired or wireless communication network, and it may be direct or via one or more intermediate entities, e.g. one or more un-trusted entities such as an untrusted operator.

An untrusted entity is an individual, organization, computer, or system whose integrity or reliability is not guaranteed, or whose reliability or trustworthiness has been compromised in some way. An untrusted entity may pose a security risk to other entities or systems with which it is connected or interacting. In the present context, an untrusted entity may be a piece of software or code that has not been verified as safe or trustworthy, or it may be a user, operator, or device that is not authorized to access certain resources or data, but, however, may be involved in forwarding information or requests between the enclave entity and the trusted entity.

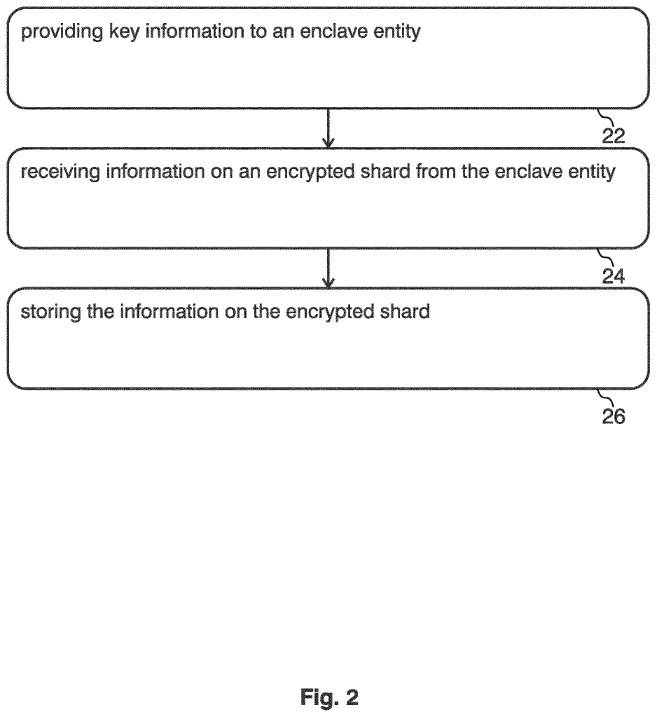

FIG. 2 shows a bock diagram of a flow chart of an example of a method 20 for a trusted entity and for securing information about a master secret key of a backup of a private memory region. The method 20 comprises providing 22 key information to an enclave entity and receiving 24 information on an encrypted shard from the enclave entity. The method 20 comprises storing 26 the information on the encrypted shard. In line with the above description, FIG. 2 illustrates the counter part at the trusted entity.

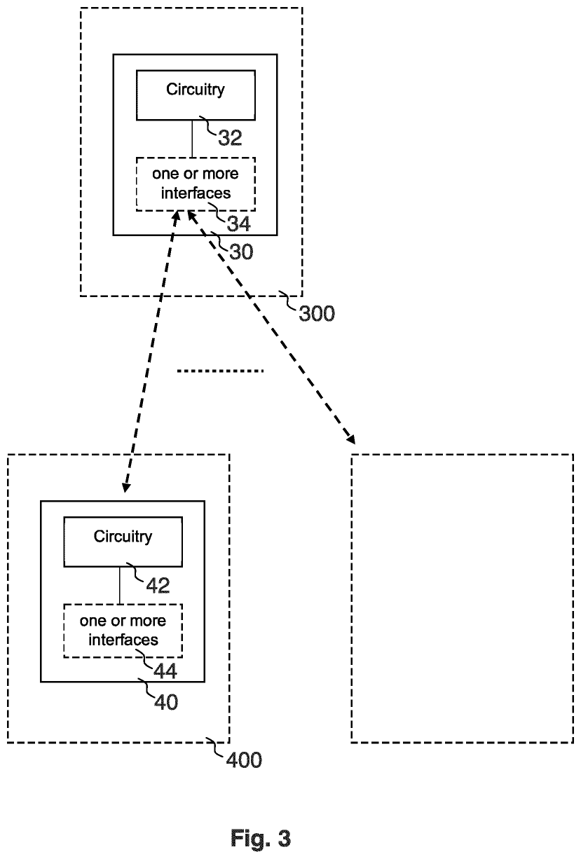

FIG. 3 shows a block diagram of an example of an apparatus 30 for an enclave entity 300 and an apparatus 40 for a trusted entity 400. The apparatus 30 for the enclave entity 300 and for securing information about a master secret key of a backup of a private memory region comprises circuitry 32 configured to perform any of the methods 10 for the enclave entity as described herein. A further example is an enclave entity 300 comprising the apparatus 30, which is shown in FIG. 3 in broken lines as it is optional from the perspective of the apparatus 30.

FIG. 3 further illustrates an example of an apparatus 40 for a trusted entity 400 and for securing information about a master secret key of a backup of a private memory region. The apparatus 40 comprises circuitry 42 configured to perform any of the methods 20 for the trusted entity as described herein. A further example is a trusted entity 400 comprising the apparatus 40, which is shown in FIG. 3 in broken lines as it is optional from the perspective of the apparatus 40.

The circuitry 32, 42 may be implemented using one or more processing units, one or more processing devices, any means for processing, such as a processor, a computer or a programmable hardware component being operable with accordingly adapted software. In other words, the described function of the circuitry 32,42 may as well be implemented in software, which is then executed on one or more programmable hardware components. Such hardware components may comprise a general-purpose processor, a Digital Signal Processor (DSP), a micro-controller, etc. A further example is an automated device, e.g. an automated system, e.g. for entertainment, gaming, exercising, vehicle, comprising an example of the apparatus 30, 40.

As further illustrated in FIG. 3, the apparatuses 30, 40 may optionally (shown in broken lines) comprise one or more interfaces 34, 44, which are coupled to the respective circuitry 32, 42. The one or more interfaces 34, 44 may correspond to one or more inputs and/or outputs for receiving and/or transmitting information, which may be in digital (bit) values according to a specified code, within a module, between modules or between modules of different entities. For example, an interface 34, 44 may comprise interface circuitry configured to receive and/or transmit information. In examples an interface 34, 44 may correspond to any means for obtaining, receiving, transmitting or providing analog or digital signals or information, e.g. any connector, contact, pin, register, input port, output port, conductor, lane, etc., which allows providing or obtaining a signal or information. An interface 34, 44 may be configured to communicate (transmit, receive, or both) in a wireless or wireline manner and it may be configured to communicate, i.e. transmit and/or receive signals, information with further internal or external components. The one or more interfaces 34, 44 may comprise further components to enable communication in a (mobile) communication system, such components may include transceiver (transmitter and/or receiver) components, such as one or more Low-Noise Amplifiers (LNAs), one or more Power-Amplifiers (PAS), one or more duplexers, one or more diplexers, one or more filters or filter circuitry, one or more converters, one or more mixers, accordingly, adapted radio frequency components, etc.

As further illustrated in FIG. 3 the respective one or more interfaces 34, 44 may be used for communication between the enclave entity 300 and one or more trusted entities 400 (further trusted entities are indicated by the broken line arrow and box). FIG. 3 hence also illustrates an example of a system comprising an enclave entity 300 and one or more trusted entities 400. In FIG. 3 the communication between the enclave entity 300 and the trusted entity is shown directly, however, in general such communication may be indirectly via intermediate network nodes, which can be untrusted.

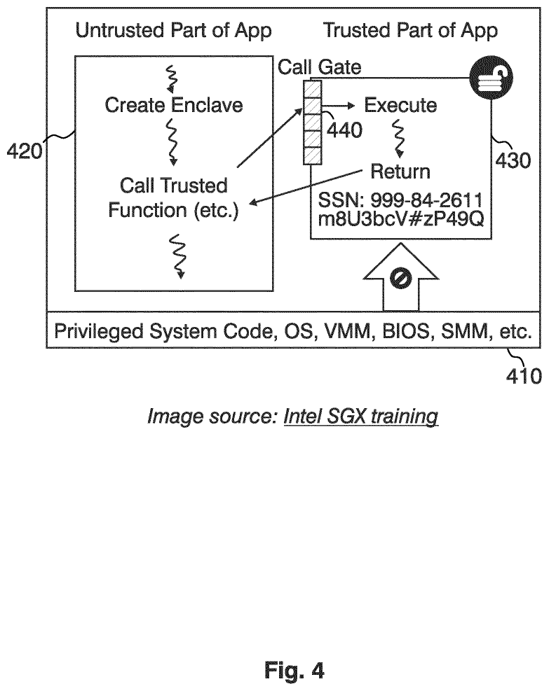

FIG. 4 illustrates an example of an enclave entity 430 of an application 410. The application 410 comprises an untrusted part 420 and a trusted part or enclave entity 430. The trusted part of the application 430 (enclave) offers a call gate 440, which can be used by the un-trusted part 420 to create an enclave and to call trusted functions in the trusted part/enclave 430. The application or its platform may comprise privileged system code, an operating system (OS), a virtual machine manager (VMM), a basic input/output system (BIOS), a system management mode (SMM), etc. In the trusted part/enclave 430 memory and instructions are encrypted as indicated by the lock, functions may be executed in—and results may be returned from—a protected memory region.

As the enclave cannot be accessed and patched from the outside, it is robust. Examples may reduce or even minimize the complexity of the security-critical part of the code (basically the code running inside the enclave). This also means some examples may minimize the amount of code running inside the enclave and favor simplicity over feature-richness.

When an untrusted part 420 of the application needs to work with sensitive data or protected code, it can spin up an enclave 430. The application can call a trusted function connecting to the enclave via a secure channel (call gate 440).

The enclave 430 may perform trusted actions like:
Decrypting sensitive data and processing the data in plain text, and
running protecting code, assuring the integrity because no one malicious intruder can access the enclave due to encryption.

When all sensitive operations are finished, the enclave returns the result to the untrusted part of the application. The untrusted part can use the result without ever having access to the sensitive component. An example of an enclave is Intel's SGX (software guard extensions). For example, together with the response, an attestation report can be returned by the enclave 430, proving the response was really generated and signed by the secured code.

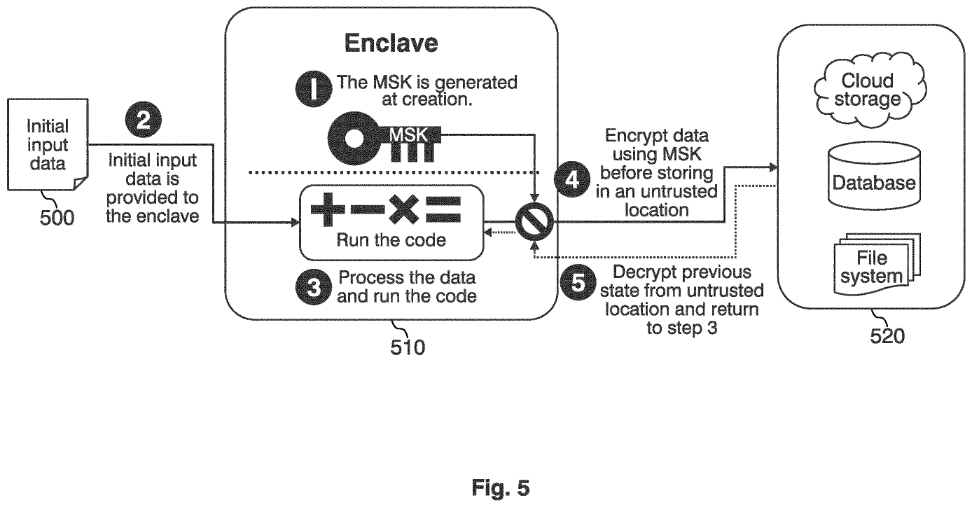

FIG. 5 depicts an example of an enclave entity 510 using an encrypted backup of a private memory region. When the enclave 510 was generated, it also generated an MSK (step 1). FIG. 5 shows initial input data 500 provided to the enclave 510 (step 2). The enclave 510 processes the data and runs certain functional or instructional code (step 3). The MSK is then used to encrypt data before storing it in an untrusted location 520 (step 4), e.g. cloud storage, a data base, a file system, etc. When reading data from the untrusted location it is decrypted before being processed (step 5). FIG. 5 illustrates saving encrypted state data in an untrusted location 520.

One use-case for enclaves is working with sensitive data in plaintext within the secure environment, while storing it in an encrypted version outside the enclave 510. To do this, the first step will be to create a master secret key (MSK) in the enclave 510 at creation time. When processing sensitive data, the data can be encrypted with the MSK, to which only the enclave has access to. The encrypted data can safely be stored in an untrusted location 520 (database, cloud provider, etc.). Whenever the encrypted data is provided to the enclave 520, the enclave 520 will be able to decrypt it and process the actual data. An assumption may be that the untrusted locations can be trusted not to lose the data—when the encrypted data is lost, there is nothing to decrypt with the MSK.

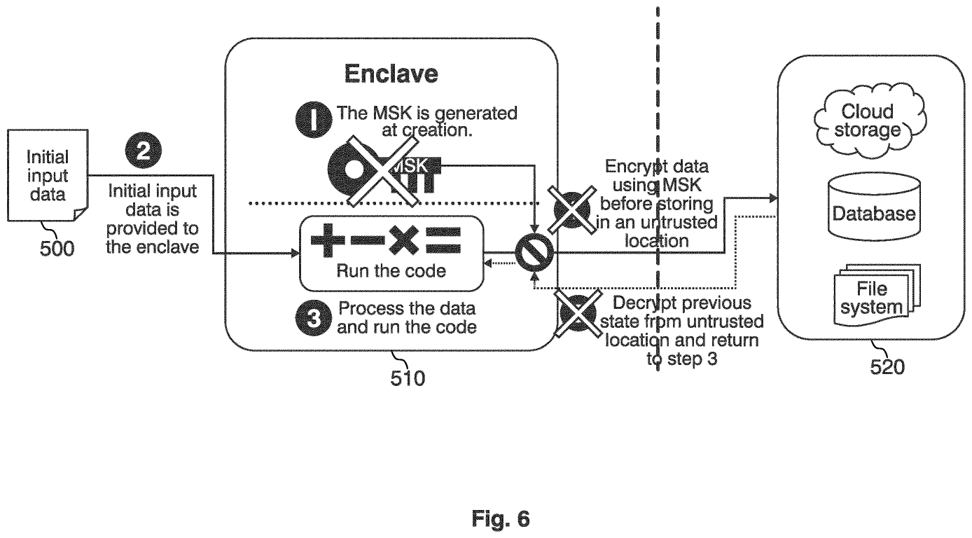

FIG. 6 shows effects resulting from a loss of a master secret key at an enclave entity. FIG. 6 illustrates the same setting as described for FIG. 5, but shows what happens when the MSK is lost or compromised.

The set-up shown FIGS. 5 and 6 allows keeping a state for the code running within the enclave 510 while nothing gets leaked in plaintext. However, this solution heavily relies on the availability and confidentiality of the MSK generated when creating the enclave 510:
When the MSK is lost, all data stored in the enclave is lost forever (encryption/decryption is not possible anymore), and
when the MSK is leaked, all data stored in the enclave 510 can be decrypted and is leaked.

To mitigate the first risk, a recovery mechanism is provided by examples, which can be implemented for the case a disaster strikes and the MSK is not available anymore. However, the recovery mechanism should not allow backdoors for misuse, potentially resulting in data leaks or data tampering (second risk). When the MSK is lost, steps 4 and 5 (encryption/decryption) cannot be applied anymore. A bunch of encrypted data stored in untrusted storage is left without the possibility to ever decrypt it, making it useless.

Whenever the MSK needs to be restored, human interaction of an operator will be required. The operator is assumed to be untrusted, meaning the operator cannot have access to sensitive data during the process of restoring the MSK for the enclave. The recovery mechanism should provide all elements required to restore the enclave to the operator, without giving the operator the possibility of modifying anything about the enclave.

The untrusted operator can choose not to restore the enclave resulting in a denial of service, which is unavoidable. Examples may focus on a solution where data stored in the enclave remains confidential and the enclave keeps its integrity. Examples may provide a key recovery mechanism for enclave-based applications, in the presence of untrusted operators.

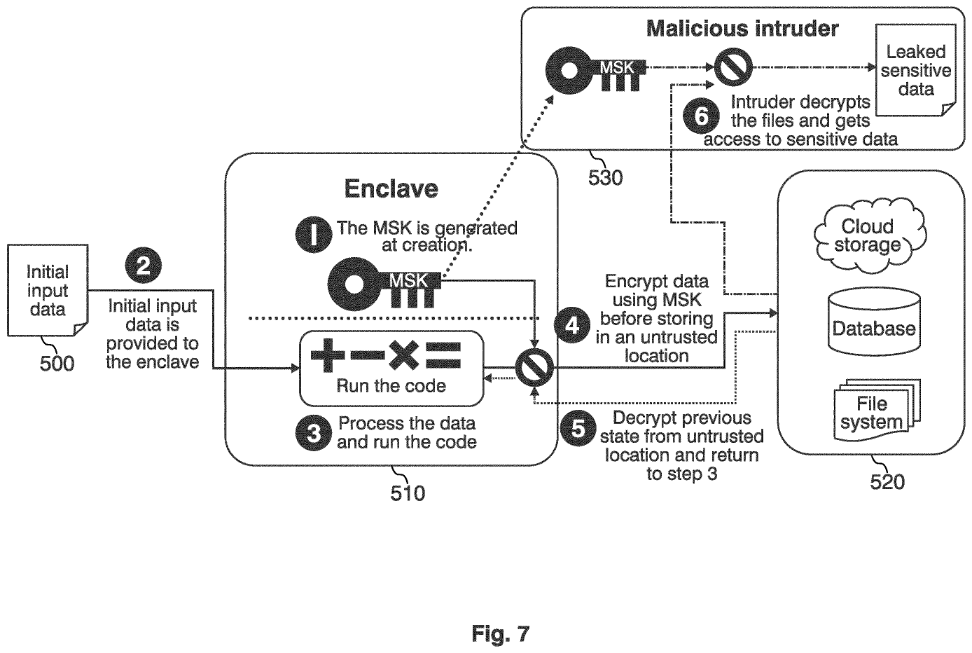

FIG. 7 illustrates effects resulting from a compromised master secret key. FIG. 7 illustrates the same scenario as FIGS. 5 and 6 with an additional malicious intruder 530. If the MSK is leaked the malicious intruder 530 can use the MSK to decrypt the files from the untrusted location 520 and get access to the sensitive data. When the MSK is compromised, all encrypted sensitive data can be decrypted by the malicious intruder 530.

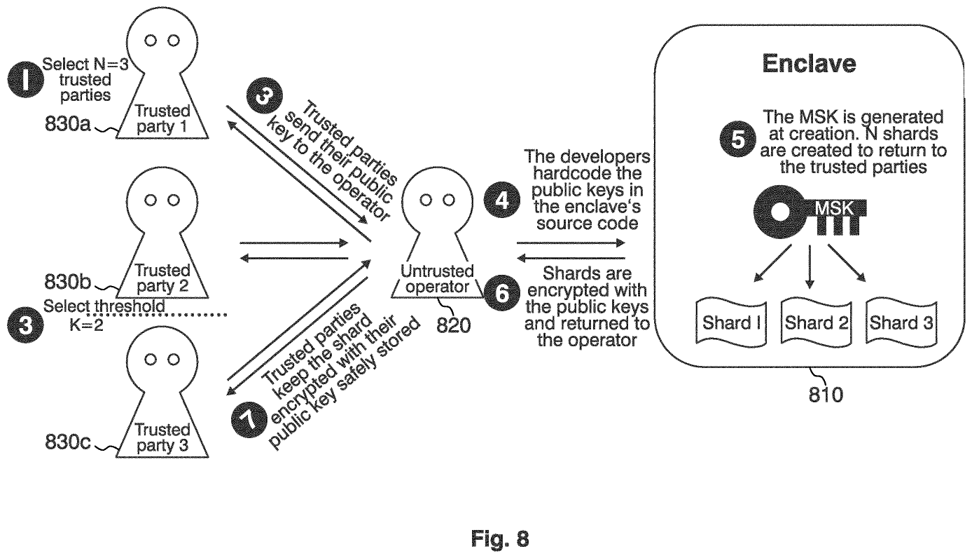

FIG. 8 depicts distribution of encrypted shards to multiple trusted entities in an example. FIG. 8 shows an enclave entity 810, which communicates with a plurality of trusted entities 830a, 830b, and 830c through an untrusted operator 820. In this example the enclave 810 has selected N=3 trusted parties 830a, 830b, and 830c. The trusted parties 830abc provide their public keys (which may be pre-generated or just generated) to the operator 820. The operator 820 provides the public keys to the enclave 810, where developers of the enclave 810 may hardcode the public keys in the enclave's source code. At the enclave 810 the MSK is generated at creation. N shards are created to return to the trusted parties. The shards are encrypted with the public keys and returned to the operator 820. The operator 820 forwards the encrypted shards to the trusted parties 830abc, and the trusted parties 830abc keep the shard encrypted with the public key safely stored.

FIG. 8 illustrates distributing encrypted shards amongst trusted parties 830abc. In this example, the MSK can be recovered when disaster strikes. N trusted parties 830 will receive a piece of information allowing the MSK to be restored, without any of the parties having access to the actual MSK. Whenever a predefined threshold K≤N of parties agree, the key can be restored.

The steps to set up the recovery mechanism are:
1. Initially, N trusted parties are selected (step 1).
2. A threshold K≤N is chosen (step 3) as the minimum number of trusted parties needed to restore the MSK.
3. Each of the trusted parties generates an asymmetric key pair and keeps their private key secret. The public key of the key pair is provided to the developers of the enclave 810 (step 2).
4. The developers hardcode the received keys in the enclave's source code (810), ensuring they are static and will never change.
5. At first boot, the enclave will generate an MSK and break it down in multiple shards (step 5). The shards are created in a way that every subset of K (or more) shards contains enough the information to rebuild the MSK, but less than K shards are insufficient.
6. The shards are encrypted with the public keys of the trusted parties and can be retrieved from the enclave 810 (step 6). This will initially be done at start-up, but the encrypted shards can be retrieved via an API call at any point in time. Each trusted party 830 will receive the shard encrypted with their public key. For example, the encrypted shards can be communicated by the untrusted operator 820 (who reads them from the enclave's output) to the trusted parties 830.
7. Each trusted party is now able to decrypt the shard. The shard should be stored safely (step 7) until the recovery process is started by the enclave operators. When possessing one decrypted shard (or K′<K shards), this will not provide enough information to retrieve the MSK, so as long as at least N−K+1 trusted parties remain trusted and keep behaving correctly, the MSK will be safe.

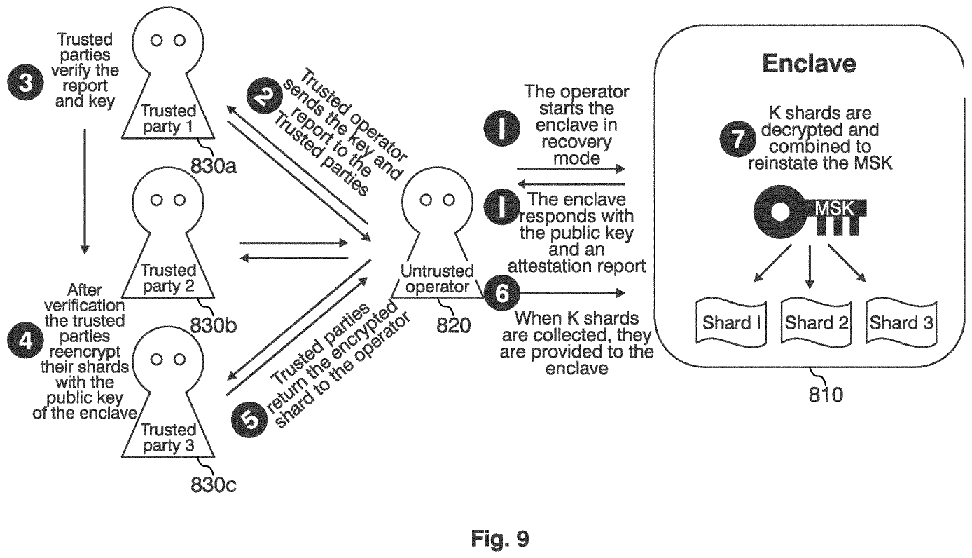

FIG. 9 shows restoring of a master secret key in an example. FIG. 9 shows the same entities as FIG. 8, the enclave 810, the untrusted operator 820, and the trusted parties 830abc. In the example of FIG. 9 the operator 820 starts the enclave 810 in recovery mode and the enclave 810 responds with its public key and, optionally, with an attestation report (step 1). Such an attestation may comprise information that allows verification or authentication of the request of the enclave entity. For example, the enclave entity 810 may sign the request with its private key and the trusted entities 830abc may verify the signature using the enclave's public key. The operator 820 sends the key and report to the trusted parties 830abc (step 2). The trusted parties 830abc verify the report and key (step 3) and after verification, the trusted parties re-encrypt their shards with the public key of the enclave 810 (step 4). The trusted parties 830abc then return the encrypted shards to the operator 820. When K shards are collected, they are provided to the enclave 810 (step 6). The enclave 810 can then decrypt the K shards and combine them to reinstate the MSK (step 7).

The method 10 for the enclave entity hence comprises restoring the master secret key by providing further key information to at least the predefined number of trusted entities (steps 1 and 2 via the untrusted operator 820);
requesting shard information from at least the predefined number of trusted entities 830abc (steps 1 and 2);
receiving encrypted shard information from at least the predefined number of trusted entities 830abc (step 6);
decrypting the encrypted shard information based on the further key information to obtain at least the predefined number of decrypted shards (step 7);
restoring the master secret key based on at least the predefined number of decrypted shards (step 7).

The method 10 for the enclave entity may further comprise providing an attestation of the enclave entity to at least the predefined number of trusted entities 830abc, to enable the trusted parties 830abc to verify the request. As illustrated by FIG. 9 the requesting of the shard information by the enclave 810 may comprise communication with the trusted entities 830abc through an untrusted operator 820. Together with the response (steps 1 and 2), an attestation report may be returned by the enclave 810, proving the response was really generated signed by the secured code.

From the perspective of the trusted entity 830abc the method 20 in this example further comprises providing information on re-encrypted shards back to the enclave entity 810 by
receiving further key information and a request for shard information from the enclave entity 810 (steps 1 and 2);
restoring the encrypted shard information (step 4);
decrypting the encrypted shard information based on the key information (step 4);
re-encrypting the shard information based on the further key information to obtain re-encrypted shard information (step 4); and
providing the re-encrypted shard information to the enclave entity 810 (steps 5 and 6).

In line with the above the method 20 at the trusted party 830abc may comprise receiving attestation information from the enclave entity 810 and verifying a restoration of the master secret key by the enclave entity 810 based on the attestation information (step 3). As already described the receiving may comprise communicating with the enclave entity 810 through an untrusted operator 820.

Examples may enable restoring the MSK. When disaster strikes and the MSK is lost, or when the enclave code is updated, the MSK can be recovered from the shards kept by the trusted parties.

1. The enclave is started in a special mode dedicated to restoring the MSK. This mode will trigger the creation of an asymmetric key pair and an attestation report. The attestation report will provide proof that the public key was generated by this specific enclave:
E.g. it will be signed by the manufacturer of the CPU,
E.g. a cryptographic fingerprint of the code running inside the enclave 810 will be provided, and/or
E.g. the attestation report will contain a hash of the public key. Anyone receiving the public key over an out-of-band channel can verify the key by hashing it and comparing the result.

2. The enclave 810 returns the public key and attestation report. The untrusted operator 820 obtains the report and the public key and sends everything to the trusted parties 830abc (steps 1 and 2).

3. The trusted parties 830abc retrieving the public key and attestation report verify that the information is actually coming from the enclave 810 by checking all bullet points described in step 1 (step 3).

4. When the trusted parties 830abc are convinced that the MSK needs to be restored, they fetch the shard that they had received and stored in step 7 of FIG. 8. Afterwards, they can decrypt it using the private key they generated in steps 1 and 2 of FIG. 8. After the shard is decrypted to plain text, it is re-encrypted (step 4) under the enclave's public key they received in step 2 (which was verified in step 3).

5. The re-encrypted shard is sent back to the enclave operator 820 (step 5), the operator 820 cannot decrypt this.

6. When at least K encrypted shards are collected by the operator 820, they are provided to the enclave 810 (step 6). The enclave 810 decrypts the shards with the private key generated in step 1 (step 7). By definition, K shards are sufficient to restore the MSK. However, the operator 820 only sees encrypted shards and will not be able to reconstruct the MSK using this information.

7. The MSK is reinstated (step 7) and the enclave 810 is restored.

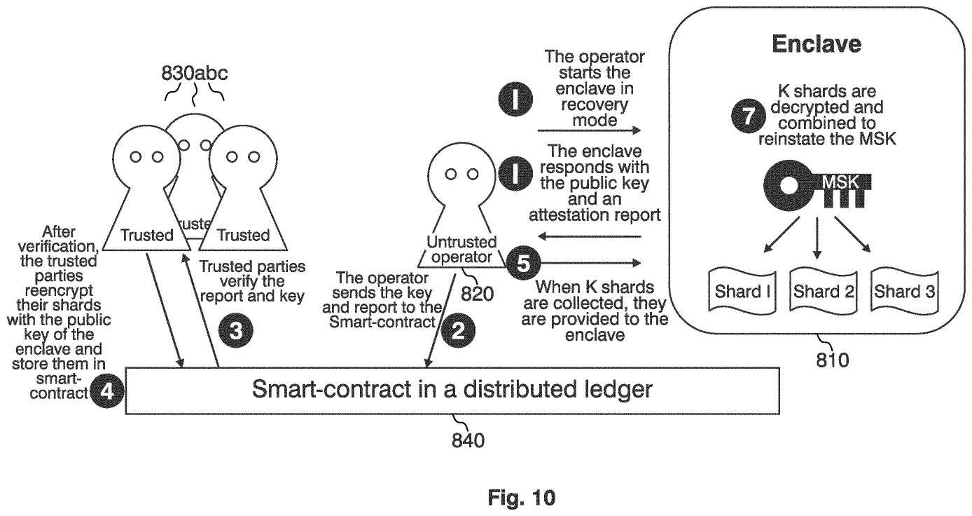

FIG. 10 illustrates documentation on a distributed ledger in an example. FIG. 10 shows the enclave 810, the untrusted operator 820, and the trusted parties 830abc in line with the previous Figs. FIG. 10 also illustrates a smart contract in a distributed ledger 840. A distributed ledger is a database that is spread across multiple computers or servers, which allows for a decentralized and transparent record-keeping system. Each computer or server in the network is connected and communicates with one another, creating a shared and synchronized ledger. The ledger can record information such as transactions, ownership, and identity, and it is maintained by multiple participants in the network who verify each other's entries. This eliminates the need for a central authority or intermediary to verify and facilitate transactions, making the process faster, cheaper, and more secure. Distributed ledgers are commonly used in blockchain technology, which is a specific type of distributed ledger that creates a secure and trusted ledger of digital transactions. In examples the distributed ledger may be a blockchain.

The distributed ledger 840 can be used in examples to document steps carried out at the enclave entity 810, which makes these steps verifiable for the trusted parties 830abc. Likewise, the trusted parties 830abc may document their steps on the distributed ledger to make these verifiable for the enclave entity 810. Hence, the method 10 for the enclave entity 810 may comprise documenting the providing of an encrypted shard to a trusted entity 830abc. The documenting may comprise storing information about the providing in the distributed ledger 840. Furthermore, the method 10 may comprise storing information about restoring the master secret key in the distributed ledger 840. Therewith, the trusted entities 830abc can verify the steps of the enclave entity 810. The method 10 for the enclave entity 810 may further comprise obtaining information about provision of an encrypted shard from a trusted entity 830abc from a distributed ledger 840 and authenticating the trusted entity 830abc using the information about the provision. This may allow the enclave entity 810 to verify the steps at the trusted entities 830abc. The method 10 may also include storing information about completing the restoring of the master secret key in the distributed ledger 840, which may document the completion for other entities.

The method 20 at the trusted entities 830abc may be adapted accordingly. The method 20 may comprise documenting reception of an encrypted shard from the enclave entity 810. The documenting may be done by storing information about the reception in the distributed ledger 840. The method 20 at the trusted entity 830abc may comprise verifying information about restoring the master secret key associated with the shard by the enclave entity 810 from the distributed ledger 840. Information about providing of the re-encrypted shard to the enclave entity 810 may be provided to a distributed ledger 840 to enable verification by the enclave entity 810.

As shown in FIG. 10 the operator 820 may start the enclave 810 in recovery mode. The enclave 810 may respond with a public key and the attestation report (step 1). The operator 820 may then send the key and report to the smart-contract in the distributed ledger 840 (step 2). The trusted parties 830abc can then obtain and verify the report and key from the smart-contract 840 (step 3). After verification, the trusted parties 830abc re-encrypt their shards with the public key of the enclave and store them in the smart-contract (step 4). The operator 820 can then collect K shards from the smart contract 840 when available and provide them to the enclave 810 (step 5). The enclave 810 can then decrypt the K shards and combine them to reinstate the MSK.

Examples may enable public network tracing of the steps carried out at the trusted entities 830abc and the enclave entity 810. When relying on trusted parties, one of the most dangerous risks is that of collusion between some of these parties, therefore it is a good idea to set the parameter K sufficiently high, so that a considerable majority of trusted parties have to turn malicious in order to break the system. In case some of these parties become malicious, they might not have enough information to reveal the secret on their own, but they can attack other trusted parties with social engineering attacks, eclipse attacks, phishing, etc. To counter this threat, trusted parties should have a described and auditable procedure for the secret key restoring procedure. This procedure should satisfy some requirements:
Trusted parties know the code that is running in the enclave, which is in “restore” mode,
Trusted parties know when the restore starts and ends, and
Trusted parties are sure that other parties know about the restore and agree to it.

One of the ways to implement such a procedure is to use public blockchain networks, that provide an immutable and auditable log of events. The extended approach in an example can be summarized as follows, cf. FIG. 10:
1. The untrusted operator (UO) 820 runs enclave 810 in recovery mode (step 1);
2. UO 820 receives enclave's public key and attestation report and publishes them to a public blockchain 840 (steps 1 and 2);
3. UO 820 notifies trusted parties 830abc that recovery event started;
4. TPs 830abc may see on the public blockchain network 840 that recovery event is really started, check the attestation report and public key (step 3);
5. TPs 830 abc then publish encrypted share to the network 840 (step 4); and
6. UO 820 feeds the shares to enclave 810 (step 5).

In addition to what is outlined with respect to FIG. 10, there are other interesting properties that can be achieved by logging events on a public blockchain 840:
Trusted parties might have committed to a certain response time, as part of their “duties” as trusted parties. This means that they commit, in case their intervention is needed, on answering within X hours. By logging their response on the blockchain 840, the trusted parties have time-stamped, tamper-resistant evidence that they respected this commitment. Consequences resulting if they fail to fulfill their commitment may include loss of their status as trusted entity.
Investigation after-the-fact is possible by auditing the events on the blockchain 840. This will reveal who performed which operation, what the response time was, how long the service was unavailable for, etc. All in a tamper-resistant fashion, guaranteed by blockchain technology.
Leaving a trace on a public blockchain 840 is also good for accountability: all the events are publicly visible, which means the users get to see when a disaster happens and how the system reacts to that.

Enclave services may need to obtain the trust of their customers. In particular, they need to convince their customers that information they are guarding on their customer's behalf remains safe even in case of a disaster (e.g., an entire data center is lost, etc.). To this end, these services may publish information about their procedures, their backup/restore mechanisms, their safeguards, kill switches, etc.

In the following some examples are summarized:

(1) A method for an enclave entity and for securing information about a master secret key of a backup of a private memory region, the method comprising generating a plurality of shards based on the master key, wherein a predefined number of the shards, which is lower or equal to a number of shards in the plurality, form an information basis for reconstructing the master secret key; receiving key information from a plurality of trusted entities; encrypting the plurality of shards individually using the key information from the plurality of trusted entities to obtain a plurality of encrypted shards; and providing the plurality of encrypted shards to the plurality of trusted entities.

(2) The method of (1) further comprising documenting the providing of an encrypted shard to a trusted entity.

(3) The method of (2), wherein the documenting comprises storing information about the providing in a distributed ledger.

(4) The method of one of (1) to (3), further comprising restoring the master secret key by providing further key information to at least the predefined number of trusted entities; requesting shard information from at least the predefined number of trusted entities; receiving encrypted shard information from at least the predefined number of trusted entities; decrypting the encrypted shard information based on the further key information to obtain at least the predefined number of decrypted shards; restoring the master secret key based on at least the predefined number of decrypted shards.

(5) The method of (4), further comprising providing an attestation of the enclave entity to at least the predefined number of trusted entities.

(6) The method of (4) or (5), further comprising storing information about restoring the master secret key in a distributed ledger.

(7) The method of one of (4) to (6), further comprising obtaining information about provision of an encrypted shard from a trusted entity from a distributed ledger and authenticating the trusted entity using the information about the provision.

(8) The method of one of (4) to (7), further comprising storing information about completing the restoring of the master secret key in a distributed ledger.

(9) The method of one of (4) to (8), wherein the requesting of the shard information comprises communication with the trusted entities through an untrusted operator.

(10) A computer program having a program code for performing a method according to one of (1) to (9), when the computer program is executed on a computer, a processor, or a programmable hardware component.

(11) An apparatus for an enclave entity and for securing information about a master secret key of a backup of a private memory region comprising circuitry configured to perform the method of one of (1) to (9).

(12) The apparatus of (11), wherein the circuitry is further configured to document the providing of an encrypted shard to a trusted entity.

(13) The apparatus of one of (11) or (12), wherein the circuitry is further configured to store information about the providing in a distributed ledger.

(14) The apparatus of one of (11) to (13), wherein the circuitry is further configured to restore the master secret key by providing further key information to at least the predefined number of trusted entities; requesting shard information from at least the predefined number of trusted entities; receiving encrypted shard information from at least the predefined number of trusted entities; decrypting the encrypted shard information based on the further key information to obtain at least the predefined number of decrypted shards; restoring the master secret key based on at least the predefined number of decrypted shards.

(15) The apparatus of (14), wherein the circuitry is further configured to provide an attestation of the enclave entity to at least the predefined number of trusted entities.

(16) The apparatus of one of (14) or (15), wherein the circuitry is further configured to store information about restoring the master secret key in a distributed ledger.

(17) The apparatus of one of (14) or (16), wherein the circuitry is further configured to obtain information about provision of an encrypted shard from a trusted entity from a distributed ledger and authenticating the trusted entity using the information about the provision.

(18) The apparatus of one of (14) to (17), wherein the circuitry is further configured to store information about completing the restoring of the master secret key in a distributed ledger.

(19) The apparatus of one of (14) to (18), wherein the circuitry is further configured to communicate with the trusted entities through an untrusted operator.

(20) An enclave entity comprising the apparatus of one of (11) to (19).

(21) A method for a trusted entity and for securing information about a master secret key of a backup of a private memory region, the method comprising providing key information to an enclave entity; receiving information on an encrypted shard from the enclave entity; and storing the information on the encrypted shard.

(22) The method of (21), further comprising documenting reception of an encrypted shard from the enclave entity.

(23) The method of (21) or (22), wherein the documenting comprises storing information about the reception in a distributed ledger.

(24) The method of one of (21) to (23), further comprising providing information on re-encrypted shards back to the enclave entity by receiving further key information and a request for shard information from the enclave entity; restoring the encrypted shard information; decrypting the encrypted shard information based on the key information; re-encrypting the shard information based on the further key information to obtain re-encrypted shard information; and providing the re-encrypted shard information to the enclave entity.

(25) The method of (24), further comprising verifying information about restoring the master secret key associated with the shard by the enclave entity from a distributed ledger.

(26) The method of (24) or (25), further comprising receiving attestation information from the enclave entity and verifying a restoration of the master secret key by the enclave entity based on the attestation information.

(27) The method of one of (24) to (26), further comprising providing information about providing of the re-encrypted shard to the enclave entity to a distributed ledger.

(28) The method of one of (24) to (27), wherein the receiving comprises communicating with the enclave entity through an untrusted operator.

(29) A computer program having a program code for performing a method according to one of (21) to (28), when the computer program is executed on a computer, a processor, or a programmable hardware component.

(30) An apparatus for a trusted entity and for securing information about a master secret key of a backup of a private memory region comprising circuitry configured to perform the method of one of (21) to (28).

(31) The apparatus of (30), wherein the circuitry is further configured to document reception of an encrypted shard from the enclave entity.

(32) The apparatus of (30) or (31), wherein the circuitry is further configured to store information about the reception in a distributed ledger.

(33) The apparatus of one of (30) to (32), wherein the circuitry is further configured to provide information on re-encrypted shards back to the enclave entity by receiving further key information and a request for shard information from the enclave entity; restoring the encrypted shard information; decrypting the encrypted shard information based on the key information; re-encrypting the shard information based on the further key information to obtain re-encrypted shard information; and providing the re-encrypted shard information to the enclave entity.

(34) The apparatus of (33), wherein the circuitry is further configured to verify information about restoring the master secret key associated with the shard by the enclave entity from a distributed ledger.

(35) The apparatus of one of (33) or (34), wherein the circuitry is further configured to receive attestation information from the enclave entity and verifying a restoration of the master secret key by the enclave entity based on the attestation information.

(36) The apparatus of one of (33) to (35), wherein the circuitry is further configured to provide information about providing of the re-encrypted shard to the enclave entity to a distributed ledger.

(37) The apparatus of one of (33) to (36), wherein the circuitry is further configured to communicate with the enclave entity through an untrusted operator.

(38) A trusted entity comprising the apparatus of one of (30) to (37).

(39) A system comprising an enclave entity of (20) and one or more trusted entities of (38).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for an enclave entity and for securing information about a master secret key of a backup of a private memory region, the method comprising
generating a plurality of shards based on the master key, wherein a predefined number of the shards, which is lower or equal to a number of shards in the plurality, form an information basis for reconstructing the master secret key;
receiving key information from a plurality of trusted entities;
encrypting the plurality of shards individually using the key information from the plurality of trusted entities to obtain a plurality of encrypted shards; and
providing the plurality of encrypted shards to the plurality of trusted entities.

2. The method of claim 1 further comprising documenting the providing of an encrypted shard to a trusted entity.

3. The method of claim 2, wherein the documenting comprises storing information about the providing in a distributed ledger.

4. The method of claim 1, further comprising restoring the master secret key by
providing further key information to at least the predefined number of trusted entities;
requesting shard information from at least the predefined number of trusted entities;
receiving encrypted shard information from at least the predefined number of trusted entities;
decrypting the encrypted shard information based on the further key information to obtain at least the predefined number of decrypted shards;
restoring the master secret key based on at least the predefined number of decrypted shards.

5. The method of claim 4, further comprising providing an attestation of the enclave entity to at least the predefined number of trusted entities.

6. The method of claim 4, further comprising storing information about restoring the master secret key in a distributed ledger.

7. The method of claim 4, further comprising obtaining information about provision of an encrypted shard from a trusted entity from a distributed ledger and authenticating the trusted entity using the information about the provision.

8. The method of claim 4 further comprising storing information about completing the restoring of the master secret key in a distributed ledger.

9. The method of claim 4, wherein the requesting of the shard information comprises communication with the trusted entities through an untrusted operator.

10. A computer program having a program code for performing a method according to claim 1, when the computer program is executed on a computer, a processor, or a programmable hardware component.

11. An apparatus for an enclave entity and for securing information about a master secret key of a backup of a private memory region comprising circuitry configured to perform the method of claim 1.

12. An enclave entity comprising the apparatus of claim 11.

13. A method for a trusted entity and for securing information about a master secret key of a backup of a private memory region, the method comprising
providing key information to an enclave entity;
receiving information on an encrypted shard from the enclave entity; and
storing the information on the encrypted shard.

14. The method of claim 13, further comprising documenting reception of an encrypted shard from the enclave entity.

15. The method of claim 14, wherein the documenting comprises storing information about the reception in a distributed ledger.

16. The method of claim 13, further comprising providing information on re-encrypted shards back to the enclave entity by
receiving further key information and a request for shard information from the enclave entity;
restoring the encrypted shard information;
decrypting the encrypted shard information based on the key information;
re-encrypting the shard information based on the further key information to obtain re-encrypted shard information; and
providing the re-encrypted shard information to the enclave entity.

17. The method of claim 16, further comprising verifying information about restoring the master secret key associated with the shard by the enclave entity from a distributed ledger.

18. The method of claim 16, further comprising receiving attestation information from the enclave entity and verifying a restoration of the master secret key by the enclave entity based on the attestation information.

19. The method of claim 16, further comprising providing information about providing of the re-encrypted shard to the enclave entity to a distributed ledger.

20. The method of claim 16, wherein the receiving comprises communicating with the enclave entity through an untrusted operator.

21. A computer program having a program code for performing a method according to claim 13, when the computer program is executed on a computer, a processor, or a programmable hardware component.

22. An apparatus for a trusted entity and for securing information about a master secret key of a backup of a private memory region comprising circuitry configured to perform the method of claim 13.

23. A trusted entity comprising the apparatus of claim 22.

24. A system with an enclave entity of claim 12 and one or more trusted entities of claim 23.
